(19) United States
(12) Patent Application Publication
(10) Pub. No.: US 2021/0244230 A1
(43) Pub. Date: Aug. 12, 2021

(54) BEVERAGE MAKER

(71) Applicant: CREM INTERNATIONAL AKTIEBOLAG, Âmotfors (SE)

(72) Inventor: Jon Olsson, Gandia, Valencia (ES)

(21) Appl. No.: 17/047,460

(22) PCT Filed: May 17, 2019
(86) PCT No.: PCT/EP2019/062825

§ 371 Date: Oct. 14, 2020

(30) Foreign Application Priority Data
May 18, 2018 (SE) 1850583-4

(51) Int. Cl. A47J 31/057; A47J 31/32

(52) U.S. Cl. CPC A47J 31/0573; A47J 31/56; A47J 31/32

(57) ABSTRACT

Device and methods for brewing a beverage from a heated liquid chamber are disclosed in which the kinetic energy of rising air bubbles injected into a water heating chamber or delivery tube entrains the liquid in the water heating chamber to a delivery spout.

### CROSS-REFERENCE TO RELATED APPLICATIONS

This application is a National Stage Application of International Application No. PCT/EP2019/062825, filed on May 17, 2019, now published as WO2019/219919 and which claims priority to Sweden Application No. 1850583-4, filed on May 18, 2018, the entire contents of which is incorporated herein by reference.

### TECHNICAL FIELD

The present invention relates to beverage makers, in particular drip beverage makers, and methods of using beverage makers, in particular drip beverage makers.

### STATE OF THE ART

A drip beverage maker, for example a coffee maker, comprises a water reservoir to hold the water used to make the beverage, a heating element, usually comprising a metal extrusion with a resistive heating element wrapped around or inside the extrusion and a transport tube through which water from the water reservoir can flow, a delivery tube from the heating element which leads up to a drip area where the delivery tube ends in a nozzle or other outlet from which water can drip, a basket or other container for a filter and coffee grounds or other beverage concentrate positioned underneath the nozzle to catch the water dripping from the delivery tube outlet, and a jug or other collecting reservoir under the filter basket into which the water flows after passing thorough the filter.

Typically, coffee is made in a drip beverage maker as follows:

a filter is placed in the filter basket, coffee grounds are added inside the opened-out filter and the filter basket fitted under the nozzle;

water is poured into the water reservoir and it flows by gravity down the transport tube to the heating element and partly up the delivery tube until the level of water in the water reservoir and the delivery tube are in equilibrium, i.e. at the same height;

the heating element is switched on which heats the metal extrusion and the water inside it tube, eventually boiling the water;

water vapour bubbles, caused by the boiling of the water in the heating element, rise up in the delivery tube. The diameter of this delivery tube is chosen so that some boiling water is able to ride upwards on the water vapour bubbles and exit via the nozzle where it drips onto the coffee grounds in the filter basket;

the water flows through the grounds, extracts the flavour from the coffee grounds and drops into the jug below.

Other beverages can be made by replacing the coffee grounds by suitable other beverage products.

A problem with such drip beverage maker is that it can only deliver water at, or very close to, boiling temperatures from the nozzle as it relies on the water vapour bubbles formed in boiling water to lift the water from the reservoir to the nozzle. Such an elevated water temperature is not always desirable as it may be too high to be the optimum temperature for the beverage being brewed. For example, the optimum temperature for coffee is brewing coffee is generally supposed to be 96° C. as a higher temperature may burn the coffee grounds while a temperature lower than around 92° C. may not extract all the flavour from the coffee grounds.

CN105286640 describes a beverage maker in which an air pump is activated to pump air into a heated water reservoir above the waterline in order to increase the pressure inside the water reservoir. When a predetermined water temperature is reached, the heater is turned off when the air pump is operated, and the increased air pressure forces the heated water out of the bottom of the reservoir and through a valve system into a drip basket. Owing to the use of increased air pressure to push the water to the drip basket, the heated water reservoir must be airtight in order to permit the air pumped into the reservoir to build up the pressure needed to push the water from the reservoir and, to avoid the risk of accidents, it must be provided with an overpressure valve.

### BRIEF DESCRIPTION OF THE INVENTION

The object of the invention is to overcome one or more of the problems of drip beverage makers. This is achieved by providing a beverage maker with a water heating chamber or pipe for heating water, an outlet port in the water heating chamber or water heating pipe connected to a delivery tube for taking water from the water heating chamber or pipe to a drip area or the like and an air injection system connected to the water heating chamber below the delivery tube. When air is injected into the water heating chamber or pipe it forms bubbles which rise up the delivery tube and carry water from the water heating chamber or pipe with them. As the bubbles of air replace the water-lifting effect caused by rising bubbles of water vapour it is possible to deliver water at any temperature. If the bubbles of air complement the water-lifting effect caused by rising bubbles of water vapour in the water heating chamber or pipe it is also possible to deliver water at temperatures close to, but less than, boiling point. The volume of air flow and/or the heating power can be controlled to adjust the temperature of the water being delivered by the delivery tube. Suitable temperature sensors can be provided in the beverage maker to provide a feedback system for controlling the flow of injected air and/or the heater power to achieve a desired temperature of the delivered water.

### BRIEF DESCRIPTION OF THE FIGURES

The invention will be described in more detail in the following, with reference to the attached drawings, in which:

FIG. 1 shows schematically a side view of a device for making a beverage in accordance with a first embodiment of the invention when the supply of pressurised air is not activated;

FIG. 2 shows the device of FIG. 1 when the supply of pressurised air is activated;

FIG. 3 shows schematically an alternative embodiment of a water heating chamber for use in a device for making a beverage in accordance with the invention

FIG. 4 shows schematically a further alternative embodiment of a water heating chamber for use in a device for making a beverage in accordance with the invention

### DETAILED DESCRIPTION

In the following the terms above and below and the like refer to when the device for making a beverage is in its normal position during brewing of a beverage.

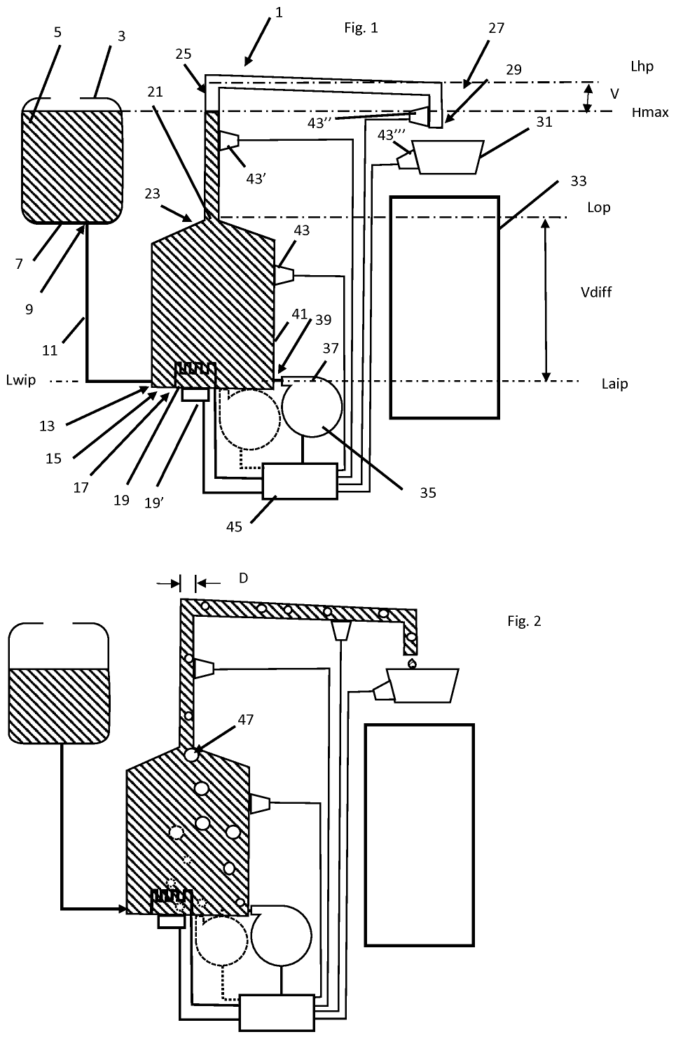

In FIG. 1, a preferred embodiment of a device for making a beverage (also called “beverage maker” for brevity in the following) 1 according to the present invention is shown schematically and not to scale in a passive state before brewing a beverage. Just like a conventional drip beverage maker this beverage maker comprises a supply water reservoir 3 which is intended to hold the water 5 used to make the beverage. For a domestic beverage maker the supply water reservoir preferably has a water capacity equal to or greater than 0.25 litres (in order to provide enough water for a single cup of beverage) and less than or equal to 2 litres (to provide enough water for several cups of beverage without having a cumbersome size). For a commercial beverage maker the water supply may be a larger reservoir or a connection to a mains water supply or the like (not shown). At or near the lowest part 7 of the reservoir is a water outlet port 9 connected to a transport tube 11 through which water from the water reservoir can flow to a water inlet port 13 at a first level Lwip at or near the base 15 of a water heating chamber 17. The water reservoir is vented to atmosphere in order to allow air to fill the water reservoir and water to leave the water reservoir through the transport tube by gravity.

The water heating chamber preferably comprises a heating means such as an internal heater element 19 and/or an external heating element 19′. Preferably the water heating chamber has a volume which is equal to or less than one tenth that of the supply water reservoir in order to reduce the volume of water which needs to be heated and thereby allow rapid heating of the water in the water heating chamber. The entrance of an outlet port 21 is positioned at a second level Lop which is above the first level Lwip and is at or near the upper end 23 of the water heating chamber. Outlet port 21 is connected to a delivery tube 25. The delivery tube extends from the water heating chamber, preferably to a brewing area, such as a drip area 27 where the delivery tube ends in a delivery spout or nozzle 29 or other outlet from which water can drip into a as a filter basket 31 or other container which can contain a filter and coffee grounds or other beverage concentrate, or a beverage capsule or the like positioned underneath the nozzle to catch the water dripping from the delivery tube outlet, and a jug 33 or cup or other collecting reservoir under the filter basket into which the beverage flows after passing thorough the filter basket or beverage capsule. The highest point in the delivery tube is at a third level Lhp which is above the second level Lop. Once water has traveled up the delivery tube and passed the third level Lhp it can flow downhill under the influence of gravity to the filter basket or the like.

Unlike a conventional drip beverage maker, a beverage maker according to the invention further is provided with:

an air pump 35 with an air outlet port 37 to an air inlet port 39 of cross-sectional area Aair connected at the base 15 (as shown in dotted lines) or near the base 15 or side wall 41 of the water heating chamber at a level Laip. The level Laip is below the level Lop of the outlet port. The air pump can inject air into the water heating chamber which then rises through the water in the water heating chamber and enters the delivery tube via the outlet port 9. This rising air can entrain water in the delivery tube and drive it over the highest point in the delivery tube (at third level Lhp) after which the water can flow into the beverage preparation area.

Preferably the vertical distance Vdiff between the air inlet port at level Laip and the outlet port at level Lop is equal to or greater than 0.5 cm, more preferably equal to or greater than 1 cm, even more preferably equal to or greater than 2 cm, yet more preferably equal to or greater than 5 cm and most preferably equal to or greater than 7 cm. It is believed that the lower the level of the air inlet port Laip and the greater the vertical distance between the air inlet port and the outlet port, the greater the kinetic energy of the air bubbles formed in the liquid and the greater the entraining effect of these bubbles on the liquid. As the vertical distance Vdiff is increased, the volume of air required to be delivered by the pump to achieve the same water entraining effect on the water in the water heating chamber decreases.

Preferably the level Laip of the air inlet port 39 is equal to or less than 10 cm above the base. More preferably the level Laip of the air inlet port is equal to or less than 5 cm above the base. Even more preferably the level Laip of the air inlet port is equal to or less than 2.5 cm above the base Most preferably the level Laip of the inlet port is at the lowest point of the base. The closer the air inlet port 39 is positioned to the base 15, the greater the vertical distance Vdiff becomes.

Preferably a beverage maker according to the invention additionally is provided with:

one or more temperature sensing means 43, 43′, 43″, 43″′ which can be arranged to respectively measure temperature and produce an output signal related to the measured temperature of the water in the water heating chamber and/or the temperature of the water near the end of the delivery tube closest to the water heating chamber and/or the temperature of the fluid at the end of the delivery tube nearest to the nozzle 29 and/or the temperature of the water and/or beverage in the filter basket; If manual control means are provided then the output signals from the temperature sensing means are arranged to provide inputs to a display (not shown) for providing a user with temperature information.

The temperature sensing means 43″ positioned at or near the end or nozzle 29 of the delivery tube measures the temperature of the mixed air and water vapour exiting the delivery tube as the water in the heating chamber warms up, and the temperature of the mixed air and water when the brewing is taking place.

Preferably a beverage maker according to the invention is automatically controlled and is additionally provided with user-operated or automatically triggered (for example by using differently-shaped filter baskets or capsules for tea and coffee and providing means for automatically detecting these differences) means for selecting the brewing of coffee or the brewing of tea.

Preferably a beverage maker is provided with automatic control means 45 such as a microprocessor with appropriate software or integrated circuit or the like, or manual control means (not shown) like one or more switches, for controlling the heating means and the air pump. If automatic control means are used then the output signals from the temperature sensing means are preferably arranged to provide inputs to the automatic control means. The automatic control means preferably is provided with switching means to adapt it to brew coffee or to adapt it to brew tea or another beverage.

Preferably the amount of heat energy supplied to the fluid can be controlled by reducing or increasing the amount of power supplied to the heating means or by switching the heater means on and off.

In a passive or switched-off state as shown in FIG. 1, where the water is not boiling and the air pump is not switched on, the water levels in the water reservoir and water heating chamber are at the same height as both containers are vented, i.e. open to the atmosphere and atmospheric pressure.

FIG. 2 shows the beverage maker of FIG. 1 in the switched-on state when a beverage is being prepared using the automatic control means. One or more predetermined brewing water temperatures have been inputted or selected by a user or manufacturer of the beverage maker and the heating means is activated. Depending on how many temperature sensing means have been provided, the predetermined brewing water temperature could be the temperature in the water heating chamber and/or the temperature at one or more ends of the delivery tube and/or the temperature in the filter basket. Preferably the predetermined brewing water temperature is the temperature measured at the outlet of the delivery tube as this gives an accurate indication of the actual temperature of the water falling onto the filter basket. As an alternative, the predetermined brewing water temperature could be the temperature of the water in the water heating chamber near the heating element as changes in the amount of heating power provided to the water heating chamber influences this most rapidly and thus gives a fast feedback. When brewing is to take place the air pump is activated to inject air into the water heating chamber. The injected air forms bubbles 47 which rise through the water in the water heating chamber and into the delivery tube via the outlet port. The diameter D of the delivery tube is made small enough so that the bubbles entrain water from the water heating chamber with them as they pass though the delivery tube and thereby transport the water to the nozzle and the filter basket. Measuring the fluid temperature in the end of delivery tube nearest to the water heating chamber may be preferred when the air pump is operating as the temperature sensing means here reacts quickly to temperature changes caused by the addition of air to the water heating chamber and the output signal from this temperature sensing means, if present, may be used in a feedback loop to control the air flow delivery rate to the water heating chamber from the air pump and/or to change the amount of heat supplied by to the water heating chamber. The activation of the air pump may be controlled by a timer so that it operates after the device has been switched on for a predetermined period of time or after the heating element has been switched on for a predetermined period of time or after a predetermined temperature has been detected in the water being heated.

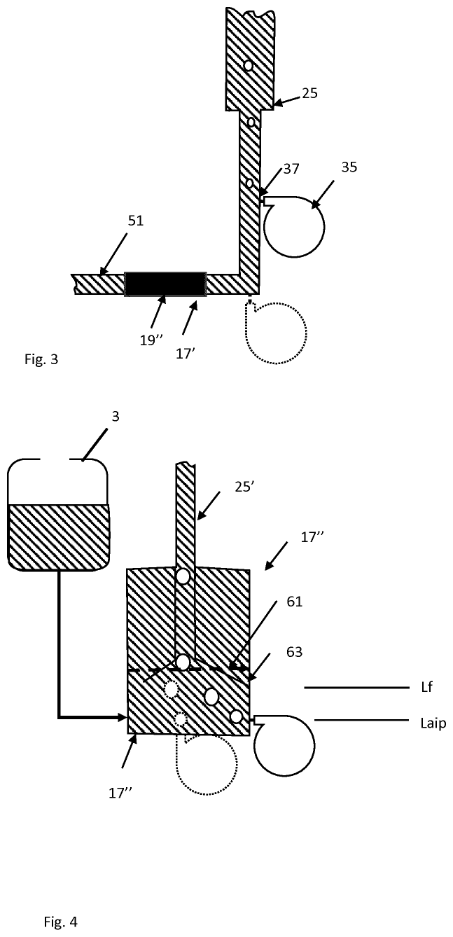

FIG. 3 shows a second embodiment of a water heating chamber for use in a beverage brewer in accordance with the present invention, in which some parts which are in common with the previous embodiment of the invention are not shown. This can replace the water heating chamber shown in the previous embodiment. In this example the water heating chamber is in the form of a duct or pipe 51 which is surrounded along part of its length by a heater element 19″. The duct may be rigid or flexible or may be comprised of flexible and rigid portions. Part of the duct is connectable to, or forms, a substantially vertically-directed delivery tube 25 and the outlet 37 of the air pump is connected to an air inlet port 37 in the duct and/or delivery tube. Preferably the outlet of the air pump is below the heater element 19″.

FIG. 4 shows a third embodiment of a water heating chamber 17″ for use a beverage brewer in accordance with the present invention, in which some parts which are in common with the previous embodiment of the invention are not shown. This can replace the water heating chamber shown in the embodiment of FIG. 1. In this example the delivery tube 25′ extends into the water heating chamber and is provided with an inverted funnel 61 or the like, the rim 63 of which is positioned at a level Lf which is higher than level Laip so that air bubbles can be captured once they enter the water heating chamber and be guided into the delivery tube. This ensures that even when the water reservoir has emptied, and the water level is low in the water heating chamber, as shown by a dashed horizontal line, the air bubbles can entrain water up the delivery tube.

Preferably the air inlet port is positioned as low as practical in the water heating chamber so that during use the air injected into the water heating chamber is always injected under the actual water level in the water heating chamber so that the water-entraining effect is effective during the whole brewing process.

The temperature of the water delivered to the filter basket or the like can be adjusted by:
i) adjusting the power supplied to the heater element in combination with a fixed or adjustable volume of air provided by the air pump; or
ii) adjusting the volume of air provided by the air pump to the water heating chamber with a fixed power supplied to the heater element.

For a constant air flow rate, at temperatures below the boiling temperature of water, Increasing the power supplied to the heater element increases the temperature of the water reaching the filter basket and reducing the power supplied to the heater element for decreases the temperature of the water reaching the filter basket.

The amount of power supplied to the heater element can be adjusted by having a variable power supply, a variable power heater or by switching the heating element on and off.

For a constant power input to the water heating chamber, at temperatures below the boiling temperature of water, Increasing the flow of air supplied to the heater element decreases the temperature of the water reaching the filter basket and reducing the flow of air supplied to the heater element increases the temperature of the water reaching the filter basket.

At temperatures where the water in the vicinity of the heater element boils, the water vapour bubbles caused by the boiling water, if sufficiently large enough and numerous enough, may also entrain water into the delivery tube which will cause boiling water to enter the filter basket. This is undesirable when is intended that the temperature of the water reaching the filter basket is to be kept below 100° C., and preferably the beverage maker according to the invention is provided with control means to reduce the risk of this occurring. If the temperature of water in the upper portion of the water heating chamber by the entrance to the delivery tube or by the nozzle of the delivery tube is over a predetermined maximum temperature then the power to the heating element can be reduced and/or the air flow from the air pump increased in order to minimise the amount of boiling water and water vapour entering the delivery tube. Preferably the beverage maker is adapted to reduce the heating effect of the heater element and/or increase the air flow from the pump in order to prevent the temperature of the water entering the brewing area from exceeding a predetermined maximum temperature.

A beverage maker according to the present invention is preferably arranged so then when it is selected to brew coffee the predetermined maximum temperature of the water delivered into the brewing area for brewing coffee is preferably equal to or greater than 85° C. and less than or equal to 99° C., more preferably equal to or greater than 90° C. and less than or equal to 98° C., even more preferably equal to or greater than 92° C. and less than or equal to 97° C. and most preferably equal to or greater than 92° C. and less than or equal to 96° C.

A beverage maker according to the present invention is preferably arranged so then when it is selected to brew tea , which normally has a lower optimal brewing temperature than coffee, the predetermined brewing maximum temperature of the water delivered into the beverage brewing area for brewing tea is preferably equal to or greater than 70° C. and less than or equal to 99° C., more preferably equal to or greater than 80° C. and less than or equal to 95° C., even more preferably equal to or greater than 85° C. and less than or equal to 94° C. and most preferably equal to or greater than 89° C. and less than or equal to 93° C.

In high power machines with large heating elements (i.e. heating elements of 1 kW power or more) there is considerable thermal inertia in the heating system and it may be impossible to entirely prevent boiling water and steam from reaching the brewing area. However the brewing device is preferably designed so that less than 10%, more preferably less than 5% and even more preferably less than 1% of the water reaching the brewing area is at a temperature over 99.5° C.

The diameter of the delivery tube is preferably equal to or greater than 4 mm and less than or equal to 15 mm, more preferably equal to or greater than 6 mm and less than or equal to 12 mm and most preferably equal to or greater than 8 mm and less than or equal to 10 mm. Preferably the cross-sectional area Adelivery of the delivery tube is greater than the cross-sectional area Aair of the air inlet port 39 in order to prevent an excess of air building up in the water heating chamber or pipe. Such an excess of air may otherwise reduce the amount of water entrained into the delivery tube. Preferably the cross-sectional area Adelivery of the delivery tube is equal to or greater than twice the cross-sectional area Aair of the air inlet port 39. More preferably the cross-sectional area Adelivery of the delivery tube is equal to or greater than four times the cross-sectional area Aair of the air inlet port 39. Even more preferably the cross-sectional area Adelivery of the delivery tube is equal to or greater than eight times the cross-sectional area Aair of the air inlet port 39. Most preferably the cross-sectional area Adelivery of the delivery tube is equal to or greater than ten times the cross-sectional area Aair of the air inlet port 39.

The flow rate of air to the water heating chamber is preferably steplessly controllable by adapting the voltage and/or current and/or pulse width of the electricity provided to the electric motor driving the air pump. When the supply water reservoir is full the water level in the water heating chamber is at its maximum height Hmax and as the water is transported through the delivery tube the water level in the water reservoir falls. This means that the vertical distance V between the water level in the water heating chamber and the highest level Lhp in the delivery tube which the water has to be carried over by the air bubbles increases during the brewing process. This means that the volume of air which has to be provided by the pump to the heated water in the water heating chamber needs to be able to be increased during the brewing process. In the beginning of a brewing cycle when the vertical distance V is at a minimum then the initial flow rate Finitial may be, for example 30 ml per minute while at the end of the brewing process when the water level in the water reservoir is much lower and the vertical distance V has increased, the air flow needed to provide the entrained water with sufficient kinetic energy to reach the highest level Lhp in the delivery tube so that it can subsequently flow via the outlet to the filter basket may be 450 or 500 ml per minute. For a beverage maker suitable for 200-1000 ml of beverage in one minute, preferably the air pump is a variable speed air pump which can be controlled to provide an air flow rate which is greater than or equal to zero cubic centimetre per minute and less than or equal to 500 cc/min. More preferably the air pump is a variable speed air pump which can be controlled to provide an air flow rate which is greater than or equal to zero cubic centimetre per minute and less than or equal to 1000 cc/min.

Even more preferably the air pump is a variable speed air pump which can be controlled to provide an air flow rate which is greater than or equal to zero cubic centimetre per minute and less than or equal to 1500 cc/min.

In a further embodiment of the invention, a beverage maker is provided which lacks a separate water reservoir. In this embodiment the water necessary for producing the beverage is filled directly into the heating chamber, thus this beverage maker will not need to have a water inlet port to the water heating chamber—instead the heating chamber can be provided with a filling port in a lid or a removable lid or the like. Preferably in such cases the filing port may be sealed during delivery of the water to the beverage preparing area and/or the delivery tube may be provided with an inverted funnel or other air bubble capture and guide means so that air bubbles can be captured once they enter the water heating chamber and be guided into the delivery tube.

In the following descriptions of methods of brewing a beverage, it is to be understood that the conventional preparatory steps required before starting brewing a beverage, such as adding water, beverage powder, leaves or ground, selecting and/or inputting and/or activating a brewing sequence, providing a power supply, etc. have been completed

A method for brewing a beverage using a device in accordance with the present invention comprises the following steps:
1) activating the heater element to heat the water in the water heating chamber or pipe,
2) activating the air pump when a predetermined temperature is measured by one or more temperature sensors,
3) adjusting the temperature of the water entering the drip basket by adjusting the air flow rate from the air pump and/or the heat output of the heater element.

Another method for brewing a beverage using a device in accordance with the present invention comprises the following steps:
1) activating the heater element to heat the water in the water heating chamber or pipe,
2) activating the air pump when a predetermined time has elapsed,
3) adjusting the temperature of the water entering the drip basket by adjusting the air flow rate from the air pump and/or the heat output of the heater element.

A further method for brewing a beverage using a device in accordance with the present invention comprises the following steps:
1) activating the heater element to heat the water in the heating chamber or pipe;
2) activating the air pump after a first predetermined time T1 (for example 20 seconds) at a first predefined voltage V1 (for example 30% of the maximum voltage Vmax) to produce a first air flow rate F1;
3) increasing the voltage supplied to the air pump after a second predetermined time T2 (for example after a further 60 seconds) to a second predefined voltage V2 (for example 45% of the maximum voltage) which is greater than the first predefined voltage to produce a second air flow rate F2;
4) optionally, increasing the voltage supplied to the air pump after a third predetermined time T3 (for example after a further 40 seconds) to a third predefined voltage V3 (for example 55% of the maximum voltage) which is greater than the second predefined voltage to produce a third air flow rate F3;
5) optionally, increasing the voltage supplied to the air pump after a fourth predetermined time T4 (for example after a further 40 seconds) to a fourth predefined voltage V4 (for example 80% of the maximum voltage) which is greater than the third predefined voltage to produce a fourth air flow rate F4;
6) optionally, increasing the voltage supplied to the air pump after a fifth predetermined time T5 (for example after a further 40 seconds) to a fifth predefined voltage V5 (for example 100% of the maximum voltage) which is greater than the fourth predefined voltage to produce a fifth air flow rate F5;
7) deactivating the heating element and the air pump.

The purpose of increasing the pump voltage after each predetermined time is to increase the airflow to compensate for the reduced incoming water pressure into the heating chamber due to reduced water pillar in the water reservoir. However, this is not necessary if the water pillar is maintained substantially constant (e.g. by refilling the reservoir from a water supply as the level in it drops) or if the pump would be operated from the beginning with a high voltage, the flow rate of the air being supplied being either kept constant at a high flow rate throughout the brewing process or being adjusted by switching the pump on and off, for example by pulse width modulation.

In any embodiment of a device and method according to the present invention the heating chamber may be provided for means for determining the water pillar in the water reservoir and/or heating chamber, such as a float gauge, contactless sensors or weighing means for determining the weight and thus the amount of water in the water reservoir and/or heating chamber. The control means could thereafter be programmed with a subroutine which continuously or stepwise increases the air pump voltage and hence the air flow rate as the water pillar falls. Such an increase could be linear or increase at a higher rate as the water pillar falls.

In any embodiment of the present invention the air delivered into the water heating chamber or pipe of the like may be directed at or past the heating element. This will cause the water nearest the heating element to move away from the heating element and reduce the tendency of local boiling of the water on the heating element. This will reduce or eliminate the formation of high-temperature water vapour bubbles.

Any of the embodiments of a method according to the invention may comprise the step of deactivating the air pump when a low water level is detected.

Any of the embodiments of a method according to the invention may comprise the step of deactivating the heating means when a low water level is detected.

Any of the embodiments or a method according to the invention may comprise the step of increasing the output of the heating element to increase the temperature of the water delivered to the beverage preparing area.

Any of the embodiments of a method according to the invention may comprise the step of decreasing the output of the heating element to decrease the temperature of the water delivered to the beverage preparing area.

Any of the embodiments of a method according to the invention may comprise the step preventing the temperature of fluid exiting the delivery tube from exceeding 99° C.

Other embodiments of the method for brewing a beverage in accordance with the present invention include the steps of controlling said supply of pressurised air to inject air at a first predetermined flow rate to said water heating chamber when a predetermined time has elapsed, increasing the rate of injection of air to a further predetermined flow rate when a further predetermined time has elapsed, repeating N times the step of increasing the rate of injection of air to a further predetermined flow rate, where N is preferably equal or greater than 5, more preferably equal to or greater than 8 and most preferably equal to or greater than 10.

An example of an embodiment of a method according to the invention with five steps (i.e. N=3) for increasing the flow rate of air injection when starting from zero air flow is shown in the following table:

| Time from start in | Heating element | Air pump voltage (% of |
|---|---|---|
| seconds | on or off | maximum voltage) |
| 0 | On | 0 |
| 20 | On | 10 |
| 80 | On | 20 |
| 120 | On | 40 |
| 160 | On | 80 |
| 200 | On | 100 |
| 240 | Off | 0 |

The above times and air pump voltages are just examples and may be varied depending on the beverage being brewed and/or user preferences. Such beverage making protocols can be provided in software or may be set by a user.

While the invention has been illustrated by examples in which an air pump is used to produce the air flow into the beverage maker, other ways and means of supplying pressurised air to the beverage maker may be used, for example a reservoir of compressed air and an appropriate valve arrangement.

Furthermore, the pressurised air may be provided via more than one air inlet at the same or different levels. If necessary, each air inlet may be provided with a non-return valve to prevent liquid from brewer from entering the air inlet.

The foregoing disclosure is not intended to limit the present invention to the precise forms or particular fields of use disclosed. It is contemplated that various alternate embodiments and/or modifications to the present invention, whether explicitly described or implied herein, are possible in the light of the disclosure. For example, the detailed disclosure describes coffee brewers and tea brewers, but the disclosure relates to other types of beverage devices. Accordingly, the scope of the invention is defined only by the claims.

1-12. (canceled)

13. A device for preparation of beverages such as tea or coffee comprising:
a water heating chamber with a heater element for heating contents of the water heating chamber or a pipe with a heater element for heating contents of the pipe;
a liquid outlet port positioned at a liquid outlet port level and in fluid communication with said water heating chamber or pipe with a heater element; said liquid outlet port being in fluid communication with a water delivery tube with a delivery outlet for delivering fluid to a brewing area,
an air inlet port in said water heating chamber or pipe with a heater element arranged at an air inlet port level which is at a vertical distance below said liquid outlet port level and/or said water delivery tube, which air inlet port is connectable to a supply of pressurized air for supplying air into said water heating chamber or pipe and/or said water delivery tube; and,
said vertical distance is equal to or greater than 0.5 cm.

14. The device according to claim 13, wherein the diameter of the delivery tube is equal to or greater than 4 mm and less than or equal to 15 mm.

15. The device according to claim 13, wherein the air inlet port is below the heater element of the pipe with a heater element or connected at a base or near the base or side wall of the water heating chamber, so that the level of the air inlet port is equal to or less than 5 cm above the base.

16. The device in accordance with claim 13, wherein said heating element is an external heating element.

17. The device in accordance with claim 13, wherein said supply of pressurized air comprises a variable speed air pump.

18. The device according to claim 13, further comprising temperature sensing means for detecting a temperature of fluid in said water heating chamber or pipe and/or said water delivery tube and/or delivery outlet.

19. The device according to claim 18, further comprising control means for operating said supply of pressurized air to input air into said water heating chamber and/or delivery tube when a predetermined water temperature is detected by one of said temperature sensing means and/or after a predetermined time has elapsed since activating the device.

20. The device according to claim 19, wherein said predetermined water temperature is equal to or greater than 85° C. and less than or equal to 99° C. when said device is adapted for brewing coffee and equal to or greater than 70° C. and less than or equal to 99° C. when said device is adapted for brewing tea.

21. A method for brewing a beverage using the device in accordance with claim 13 that comprises the following steps:
a) providing a beverage liquid to said water heating chamber or pipe and activating the heater element to heat the water in the water heating chamber or pipe,
b) activating an air pump to form air bubbles which entrain water to the delivery outlet when a predetermined temperature is measured by one or more temperature sensors;
c) adjusting a temperature of water entering a drip basket by adjusting an air flow rate from the air pump and/or a heat output of the heater element.

22. A method for brewing a beverage using the device in accordance with claim 13 comprises the following steps:
a) providing a beverage liquid to said water heating chamber or pipe and activating the heater element to heat water in the water heating chamber or pipe,
b) activating an air pump to form air bubbles which entrain water to the delivery outlet when a predetermined time has elapsed;
c) adjusting temperature of water entering a drip basket by adjusting an air flow rate from the air pump and/or a heat output of the heater element.

23. A method for preparing a beverage by means of the device according to claim 13 that it comprises the following steps:
providing a beverage liquid to said water heating chamber or pipe, heating contents of said water heating chamber or pipe;
setting a predetermined maximum temperature of water delivered into the brewing area wherein said predetermined maximum temperature of the water delivered into the brewing area is equal to or greater than 85° C. and less than or equal to 99° C. for brewing coffee and equal to or greater than 70° C. and less than or equal to 99° C. for brewing tea;
determining a temperature of fluid in said water heating chamber or pipe and/or said water delivery tube and/or delivery outlet; and,
controlling said supply of pressurized air to inject air at a first predetermined flow rate to said water heating chamber when a temperature of fluid sensed in said water heating chamber or pipe and/or said water delivery tube and/or delivery outlet reaches said predetermined maximum temperature of water delivered into the brewing area; and/or,
controlling said supply of pressurized air to inject air at a first predetermined flow rate to said water heating chamber when a predetermined time has elapsed, increasing a rate of injection of air to a further predetermined flow rate when a further predetermined time has elapsed, repeating N times the step of increasing the rate of injection of air to a further predetermined flow rate, where N is preferably equal or greater than 5 and/or,
controlling said supply of pressurized air to inject air at an increasing flow rate as a water pressure in the water heating chamber falls, to entrain water to the delivery outlet with the injected air.

24. Method according to claim 23, further comprising measuring a temperature of the fluid in a delivery spout and/or said delivery tube and increasing the flow rate of the supply of pressurized air and/or reducing a power supplied to a heater element if the measured temperature of the fluid in the delivery spout and/or delivery tube is above the predetermined maximum temperature of the water delivered into the brewing

25. The method according to claim 21, further comprising the step of preventing a temperature of fluid exiting the delivery tube from exceeding 99° C.

26. The method according to claim 22, further comprising the step of preventing a temperature of fluid exiting the delivery tube from exceeding 99° C.

27. The method according to claim 23, further comprising the step of preventing a temperature of fluid exiting the delivery tube from exceeding 99° C.

28. The method according to claim 24, further comprising the step of preventing a temperature of fluid exiting the delivery tube from exceeding 99° C.
